(19) United States
(12) Patent Application Publication
(10) Pub. No.: US 2021/0406563 A1
(43) Pub. Date: Dec. 30, 2021

(54) DETERMINATION DEVICE, DETERMINATION METHOD, AND STORAGE MEDIUM STORING PROGRAM

(71) Applicant: TOYOTA JIDOSHA KABUSHIKI KAISHA, Toyota-shi (JP)

(72) Inventors: Kenki UEDA, Edogawa-ku (JP); Ryosuke TACHIBANA, Shinagawa-ku (JP); Jun HATTORI, Chofu-shi (JP); Takashi KITAGAWA, Kodaira-shi (JP); Hirofumi OHASHI, Chiyoda-ku (JP); Toshihiro YASUDA, Osaka-shi (JP); Tetsuo TAKEMOTO, Edogawa-ku (JP)

(73) Assignee: TOYOTA JIDOSHA KABUSHIKI KAISHA, Toyota-shi (JP)

(21) Appl. No.: 17/304,478

(22) Filed: Jun. 22, 2021

(30) Foreign Application Priority Data
Jun. 30, 2020 (JP) 2020-113363

(51) Int. Cl. G06K 9/00; G06T 7/20; B62D 15/02

(52) U.S. Cl. CPC G06K 9/00805; G06T 7/20; G06K 9/00369; G06K 2209/23; G06T 2207/30261; G06T 2207/30196; G06T 2207/30241; B62D 15/021

(57) ABSTRACT

A determination device includes a processor. The processor is configured to detect an object in an image captured by an image capture section provided at a vehicle, generate a determination area in accordance with a direction of movement of the vehicle based on travel information of the vehicle and based on a position and a speed of the object, and determine danger to be present in a case in which the object is present in the determination area.

### CROSS-REFERENCE TO RELATED APPLICATION

This application is based on and claims priority under 35 USC 119 from Japanese Patent Application No. 2020-113363 filed on Jun. 30, 2020, the disclosure of which is incorporated by reference herein.

### BACKGROUND

### Technical Field

The present disclosure relates to a determination device, a determination method, and a storage medium storing a program that perform a danger determination when a vehicle approaches an object.

### Related Art

Japanese Patent Application Laid-Open (JP-A) No. 2010-191793 discloses a warning display device that warns a driver of the presence of an object with which there is a danger of the vehicle driven by the driver colliding.

This warning display device includes a first image capture section that acquires peripheral images in which the vehicle surroundings are captured, a dangerous object detection section that detects a dangerous object with which there is a danger of the vehicle colliding based on the peripheral images, a warning image generation section that generates a warning image in which the dangerous object detected in a peripheral image by the dangerous object detection section is emphatically displayed, and a display section that displays the warning image.

The dangerous object detection section in JP-A No. 2010-191793 employs pattern matching in dangerous object determination, and computes correlation values based on the relative positions of the vehicle and the object. Since information such as the speed and movement direction of the object are not taken into consideration, it is not possible to compute a danger level correctly. Moreover, since determination does not take movement of the vehicle into account, it is not possible to compute a danger level in a direction of movement of the vehicle.

### SUMMARY

An object of the present disclosure is to provide a determination device, a determination method, and a storage medium storing a program that performs a danger determination by taking information such as a position, a speed, and the like of an object, and a travel information of an vehicle, into consideration.

A determination device of a first aspect includes a detection section configured to detect an object in an image captured by an image capture section provided at a vehicle, a generation section configured to generate a determination area in accordance with a direction of movement of the vehicle based on travel information of the vehicle and based on a position and a speed of the object, and a determination section configured to determine danger to be present in a case in which the object is present in the determination area.

In the determination device of the first aspect, the detection section detects the object in the captured image captured by the image capture section provided at the vehicle, and the generation section generates the determination area in accordance with the direction of movement of the vehicle. Note that the object may be another vehicle, a pedestrian, or the like. The “determination area in accordance with a direction of progress” is an area extending along a trajectory on which the vehicle is about to proceed and that has a prescribed width.

The determination area is generated based on the travel information acquired from the vehicle, and based on the position and a speed of the object. Examples of the travel information include a steering angle of a steering wheel in the vehicle, and actuation information of an indicator light. The determination device determines danger to be present in a case in which the determination section determines the object to be present in the determination area. This determination device enables information such as the position and the speed of the object, and the travel information of the vehicle, to be taken into consideration during danger determination.

A determination device of a second aspect is the determination device of the first aspect, wherein the determination section is further configured to compute a danger level with respect to the object present in the determination area, and determine danger to be present in a case in which the computed danger level exceeds a threshold.

In the determination device of the second aspect, the determination section quantifies the dangerousness of the object present in the determination area as the danger level, and performs danger determination based on whether or not the danger level exceeds the threshold. This determination device enables danger to be determined according to the extent of a positional relationship between the vehicle and the object.

A determination device of a third aspect is the determination device of the second aspect, wherein the generation section is further configured to generate plural of the determination areas based on the travel information and based on the position and the speed of the object. The determination section is further configured to compute the danger level for each of the determination areas and to determine danger to be present in a case in which the danger level exceeds a threshold in any one of the determination areas.

In the determination device of the third aspect, the generation section generates the plural determination areas based on the travel information and based on the position and the speed of the object, and the determination section performs the danger determination in each of the determination areas. This determination device is thereby capable of taking plural conditions, such as the position and the speed of the object, into account during danger determination, thereby enabling danger to be determined according to circumstances.

A determination device of a fourth aspect is the determination device of any one of the first aspect to the third aspect, wherein the determination section is further configured to maintain a determination that danger is present at a current timing in a case in which danger has been determined to be present based on the captured image in a prescribed number of preceding frames.

In the determination device of the fourth aspect, the determination section performs the danger determination based on the captured image in the prescribed number of preceding frames. In this determination device, maintaining the danger determination over a prescribed duration enables determination results that err on the safe side, even if determination results regarding a given object vary between individual frames.

A fifth aspect is a non-transitory storage medium storing a program. The program causes a computer to execute processing including detection processing to detect an object in an image captured by an image capture section provided at a vehicle, generation processing to generate a determination area in accordance with a direction of movement of the vehicle based on travel information of the vehicle and based on a position and a speed of the object, and determination processing to determine danger to be present in a case in which the object is present in the determination area.

The program recorded on the non-transitory storage medium of the fifth aspect causes a computer to execute the following processing. Namely, the object in the image captured by the image capture section provided at the vehicle is detected during the detection processing, and the determination area is generated according to the direction of movement of the vehicle during the generation processing. Note that the object, the “determination area in accordance with a direction of progress”, and the travel information are as defined previously. The determination area is generated based on the travel information acquired from the vehicle, and based on the position and the speed of the object. The computer determines danger to be present in a case in which the object is determined to be present in the determination area during the determination processing. This program recorded in the storage medium enables information such as the position and the speed of the object, and the travel information of the vehicle, to be taken into consideration during the danger determination.

The present disclosure enables danger determination to be performed by taking information such as the position, the speed, and the like of the object, and the travel information of the vehicle, into consideration.

### BRIEF DESCRIPTION OF THE DRAWINGS

An exemplary embodiment of the present disclosure will be described in detail based on the following figures, wherein:

FIG. 1 is a diagram illustrating a schematic configuration of a vehicle according to an exemplary embodiment;

FIG. 2 is a block diagram illustrating a hardware configuration of a vehicle of an exemplary embodiment;

FIG. 3 is a block diagram illustrating a configuration of ROM of a controller of an exemplary embodiment;

FIG. 4 is a block diagram illustrating configuration of storage of a controller of an exemplary embodiment;

FIG. 5 is a block diagram illustrating functional configuration of a CPU of a controller of an exemplary embodiment;

FIG. 6 is a diagram illustrating an example of a captured image of an exemplary embodiment;

FIG. 7 is a diagram to explain determination areas of an exemplary embodiment;

FIG. 8 is a diagram to explain determination areas of an exemplary embodiment;

FIG. 9 is a flowchart illustrating a flow of determination processing by a controller of an exemplary embodiment; and

FIG. 10 is a flowchart illustrating a flow of report processing by a controller of an exemplary embodiment.

### DETAILED DESCRIPTION

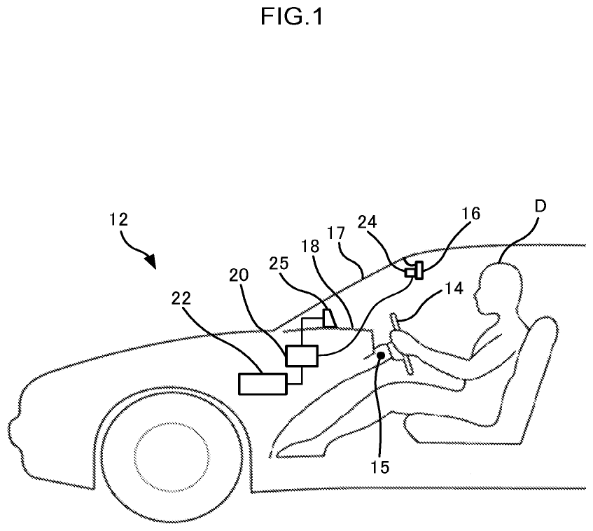

As illustrated in FIG. 1, a controller 20, serving as a determination device according to an exemplary embodiment of the present disclosure, is installed in an vehicle 12, this being a vehicle occupied by a driver D. In addition to the controller 20, the vehicle 12 also includes electronic control units (ECU) 22, a camera 24, and a reporting device 25. The ECUs 22, the camera 24, and the reporting device 25 are each connected to the controller 20.

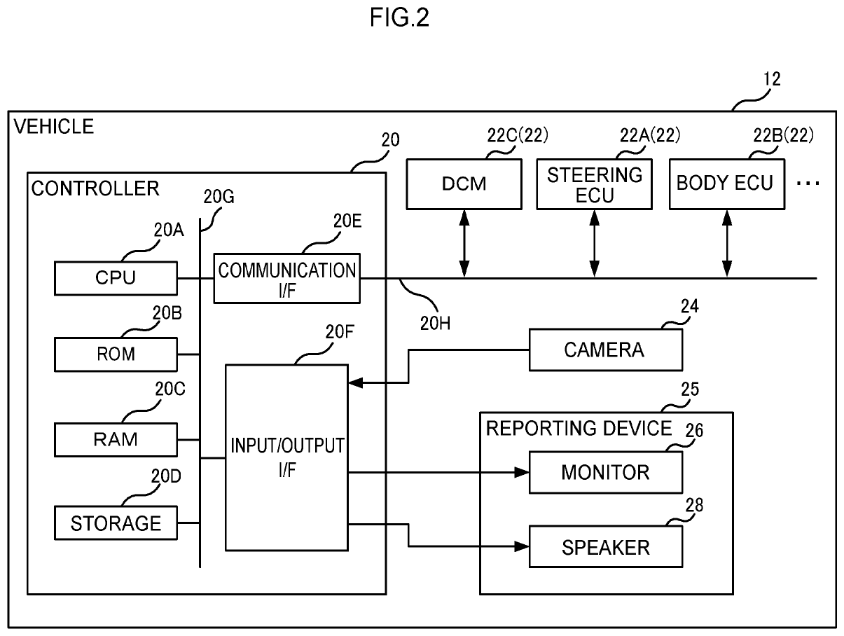

The ECUs 22 are provided as control devices that control respective sections of the vehicle 12 and also perform external communication. As illustrated in FIG. 2, the ECUs 22 of the present exemplary embodiment include a steering ECU 22A, a body ECU 22B, and a data communication module (DCM) 22C.

The steering ECU 22A has a function of controlling electric power steering. The steering ECU 22A is input with a signal from a non-illustrated steering angle sensor connected to a steering wheel 14 (see FIG. 1). The body ECU 22B has a function of controlling various lights. The body ECU 22B is input with an operation signal when for example an indicator light lever 15 (see FIG. 1) has been operated. The DCM 22C functions as a communication device to perform communication external to the vehicle 12.

As illustrated in FIG. 1, the camera 24 is provided at a vehicle front side of a rear view mirror 16. The camera 24 captures forward from the vehicle 12 through a front windshield 17.

The reporting device 25 is provided on an upper face of a dashboard 18. As illustrated in FIG. 2, the reporting device 25 includes a monitor 26 and a speaker 28. The monitor 26 is provided facing toward a vehicle rear side so as to be visible to the driver D. The speaker 28 may be provided separately to the reporting device 25 instead of in a main body of the reporting device 25. The speaker 28 may double as an audio speaker provided in the vehicle 12.

The controller 20 is configured including a central processing unit (CPU) 20A, read only memory (ROM) 20B, random access memory (RAM) 20C, storage 20D, a communication interface (I/F) 20E, and an input/output I/F 20F. The CPU 20A, the ROM 20B, the RAM 20C, the storage 20D, the communication I/F 20E, and the input/output I/F 20F are connected together so as to be capable of communicating with each other through an internal bus 20G.

The CPU 20A is a central processing unit that executes various programs and controls various sections. Namely, the CPU 20A reads a program from the ROM 20B, and executes the program using the RAM 20C as a workspace.

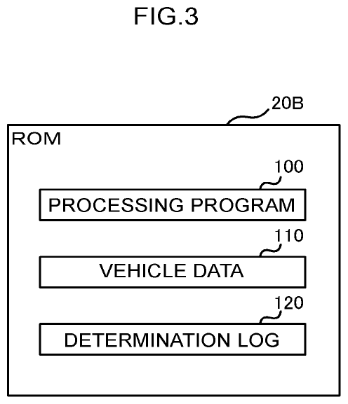

The ROM 20B stores various programs and various data. As illustrated in FIG. 3, the ROM 20B of the present exemplary embodiment stores a processing program 100, vehicle data 110, and a determination log 120. Note that the processing program 100, the vehicle data 110, and the determination log 120 may be stored in the storage 20D.

The processing program 100 is a program for performing determination processing and report processing, described later. The vehicle data 110 is data in which a track width between the tires of the vehicle 12, an installation height of the camera 24, and the like are stored. The determination log 120 is data in which determination results of the determination processing are stored. The determination log 120 may be temporarily stored in the RAM 20C.

As illustrated in FIG. 2, the RAM 20C serves as a workspace that temporarily stores programs and data.

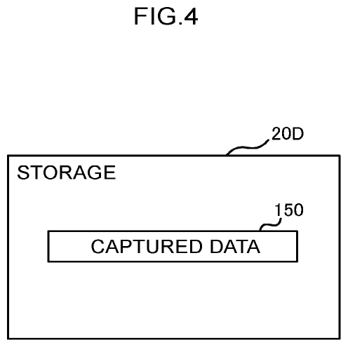

The storage 20D is configured by a hard disk drive (HDD) or a solid state drive (SSD), and stores various programs and various data. As illustrated in FIG. 4, the storage 20D of the present exemplary embodiment stores captured data 150 relating to captured images that have been captured by the camera 24. In the present exemplary embodiment, the captured data 150 may include captured images when danger has been determined to be present by the determination processing, captured images when an accident has actually occurred, and so on. Note that instead of being stored in the storage 20D, the captured data 150 may be stored in a secure digital (SD) card, universal serial bus (USB) memory, or the like connected to the controller 20.

The communication I/F 20E is an interface for connecting to the respective ECUs 22. This interface employs a CAN communication protocol. The communication I/F 20E is connected to the respective ECUs 22 through an external bus 20H.

The input/output I/F 20F is an interface for communicating with the camera 24 installed to the vehicle 12, as well as with the monitor 26 and the speaker 28 of the reporting device 25.

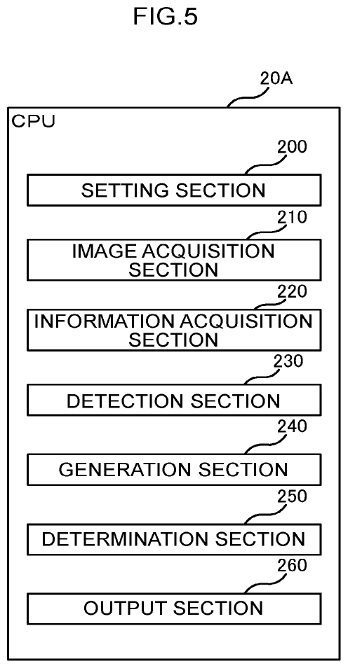

As illustrated in FIG. 5, the CPU 20A of the controller 20 of the present exemplary embodiment executes the processing program 100 in order to function as a setting section 200, an image acquisition section 210, an information acquisition section 220, a detection section 230, a generation section 240, a determination section 250, and an output section 260.

The setting section 200 has a function of setting a track width of the vehicle 12 and an installation height of the camera 24. The setting section 200 is operated by an operator at the time of installation of the controller 20, the camera 24, and the reporting device 25 so as to set the track width of the vehicle 12 and the installation height of the camera 24. The data thus set is stored as the vehicle data 110.

The image acquisition section 210 has a function of acquiring captured images captured by the camera 24.

The information acquisition section 220 has a function of acquiring travel information for the vehicle 12 from the respective ECUs 22 through CAN information. Note that, for example, the information acquisition section 220 acquires steering angle information from the steering ECU 22A, and acquires indicator light actuation information from the body ECU 22B. The information acquisition section 220 may also acquire weather information, traffic information, and the like from an external server via the DCM 22C.

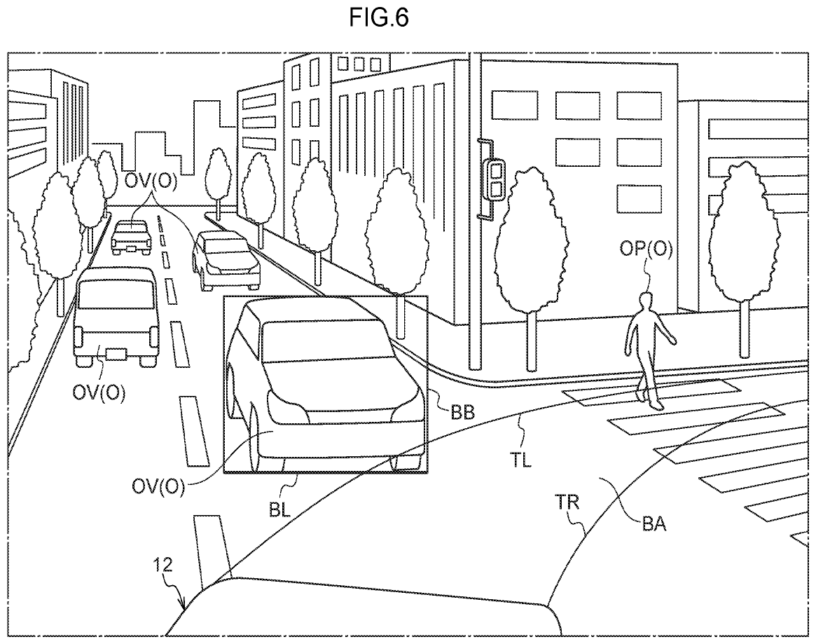

The detection section 230 has a function of detecting any objects O in a captured image captured by the camera 24. The object O may be a vehicle OV traveling on the road, or may be a pedestrian OP crossing the road (see FIG. 6).

The generation section 240 has a function of generating determination areas DA according to the direction of movement of the vehicle 12 based on the CAN information acquired by the information acquisition section 220, as well as the position and speed of the object O. As illustrated in FIG. 6, specifically, the generation section 240 generates a basis area BA according to the steering angle of the steering wheel 14. The basis area BA is defined as an area between a trajectory TL and a trajectory TR located on both vehicle width direction sides of the vehicle 12 and extending in the direction of movement of the vehicle 12. The trajectory TL on the vehicle width direction left side corresponds to a trajectory of a left front wheel of the vehicle 12, and the trajectory TR on the vehicle width direction right side corresponds to a trajectory of a right front wheel of the vehicle 12.

The generation section 240 also generates the determination areas DA according to the CAN information and the position and speed of the object O. The determination areas DA are areas set with respect to the basis area BA so as to have depth and so as to a have a width that has been increased or decreased with respect to the trajectory TL and trajectory TR. Note that in the present exemplary embodiment, three of the determination areas DA are set, namely a first area A1, a second area A2, and a third area A3.

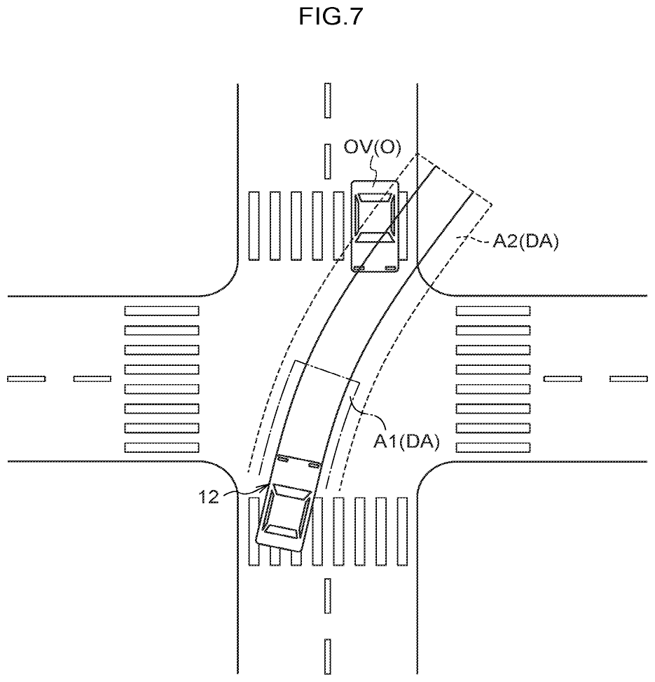

The first area A1 is a determination area DA solely based on the position of the vehicle 12. In cases in which the object O is a vehicle OV, as illustrated in Table 1, the first area A1 is set with a depth range spanning from the vehicle 12 to 8 m away from the vehicle 12, and is normally set with a width range corresponding to the track width. Moreover, in cases in which an indicator light is actuated, the first area A1 is set wider than normal, namely to a track width range+1 m. The single-dotted dashed lines in FIG. 7 represent an example of the first area A1 when set for the vehicle OV when an indicator light is actuated. A risk level of 1.0 is applied in cases in which the vehicle OV has entered the first area A1.

TABLE 1
Vehicle OV

| First area A1 | | |
|---|---|---|
| Depth | Left-right width | Risk level |
| 8 m from vehicle 12 | Track width of vehicle 12 | 1.0 |
| | Track width of vehicle 12 + | 1.0 |
| | 1 m on left/right (when | |
| | indicator light actuated) | |

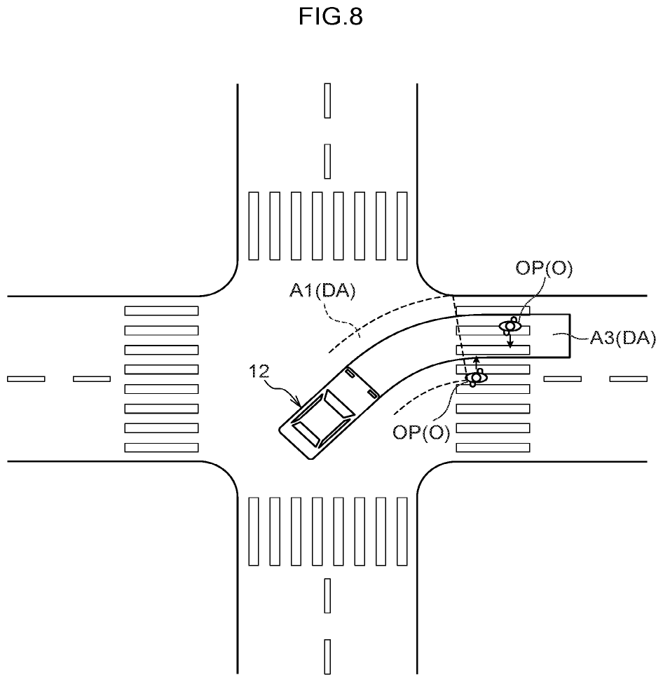

In cases in which the object O is a pedestrian OP, as illustrated in Table 2, the first area A1 is set with a depth range spanning from the vehicle 12 to 8 m away from the vehicle 12, and set with a width range corresponding to the track width+2 m. Namely, the first area A1 is wider in cases in which the object O is the pedestrian OP than in cases in which the object O is the vehicle OV. The dashed lines in FIG. 8 represent an example of the first area A1 when set for the pedestrian OP. A risk level of 1.0 is applied in cases in which the pedestrian OP has entered the first area A1.

TABLE 2
Pedestrian OP

| First area A1 | | |
|---|---|---|
| Depth | Left-right width | Risk level |
| 8 m from vehicle 12 | Track width of vehicle 12 + | 1.0 |
| | 2 m on left/right | |

The second area A2 is a determination area DA that reflects a vehicle front-rear direction speed of the object O. The second area A2 is set as illustrated in Table 3 both in cases in which the object O is a vehicle OV and in cases in which the object O is a pedestrian OP. The second area A2 is set with depth ranges spanning from the vehicle 12 to 8 m to 14 m away from the vehicle 12, and set with a width range corresponding to the track width. In cases in which the object O has entered the second area A2, a risk level of 1.0 is applied if within a range spanning 8 m from the vehicle 12, a risk level of 0.9 is applied if within a range spanning 12 m from the vehicle 12, and a risk level of 0.8 is applied if within a range spanning 14 m from the vehicle 12.

Moreover, in cases in which the depth range is set so as to span 12 m from the vehicle 12 and an indicator light is actuated, the second area A2 is set with a width range corresponding to the track width+1 m. A risk level of 0.9 is applied in cases in which an object O has entered this second area A2. In cases in which the depth range is set so as to span 14 m from the vehicle 12 and an indicator light is actuated, the second area A2 is set with a width range corresponding to the track width+2 m. The dashed lines in FIG. 7 represent an example of the second area A2 when set for the vehicle OV when an indicator light is actuated, namely with a range spanning from the vehicle 12 to 14 m from the vehicle 12 and with a width range corresponding to the track width+2 m. A risk level of 0.8 is applied in cases in which the object O has entered this second area A2.

TABLE 3
Vehicle OV or pedestrian OP

| Second area A2 | | |
|---|---|---|
| Depth | Left-right width | Risk level |
| 8 m from vehicle 12 | Track width of vehicle 12 | 1.0 |
| 12 m from vehicle 12 | | 0.9 |
| 14 m from vehicle 12 | | 0.8 |
| 12 m from vehicle 12 | Track width of vehicle 12 + | 0.9 |
| | 1 m on left/right (when | |
| | indicator light actuated) | |
| 14 m from vehicle 12 | Track width of vehicle 12 + | 0.8 |
| | 2 m on left/right (when | |
| | indicator light actuated) | |

The third area A3 is a determination area DA that reflects a left-right direction speed of the object O. The third area A3 is set as illustrated in Table 4 both in cases in which the object O is a vehicle OV and in cases in which the object O is a pedestrian OP. The third area A3 is set with a depth range spanning from the vehicle 12 to 8 m away from the vehicle 12, and set with a specific width range. In cases in which the object O has entered the third area A3, a risk level of 1.0 is applied if the object is at a left-right direction width position corresponding to the track width range, a risk level of 0.8 is applied if the object is at a left-right direction width position corresponding to the track width range+an inner/outer wheel trajectory difference, and a risk level of 0.5 is applied if the object is at a left-right direction width position corresponding to a range of a path of the vehicle 12+an inner/outer wheel trajectory difference+a human stopping distance. The solid line in FIG. 8 represents an example of the third area A3 when set for the pedestrian OP with a depth range spanning from the vehicle 12 to 8 m away from the vehicle 12 and with a width range corresponding to the track width.

TABLE 4
Vehicle OV or pedestrian OP

| Third area A3 | | |
|---|---|---|
| Depth | Left-right width | Risk level |
| 8 m from vehicle 12 | Track width of vehicle 12 | 1.0 |
| | Track width of vehicle 12 + | 0.8 |
| | inner/outer turning sweep | |
| | Path of vehicle 12 + | 0.5 |
| | inner/outer turning sweep + | |
| | human stopping distance | |

As illustrated in FIG. 5, the determination section 250 has a function of determining danger to be present in cases in which an object O is in a determination area DA generated by the generation section 240. Specifically, the determination section 250 computes a danger level with respect to the object O in the determination area DA, and determines danger to be present in cases in which the computed danger level exceeds a threshold of 0.8. In particular, the determination section 250 of the present exemplary embodiment computes a danger level for each of the determination areas DA, namely the first area A1 to the third area A3, and determines danger to be present in cases in which the danger level in any one of the determination areas DA exceeds the threshold.

Note that the danger level for the first area A1 is computed using Equation 1:

Danger level=risk level Equation 1

According to Equation 1, this determination is based solely on the position of the vehicle 12, and the danger level is a value equivalent to the risk level.

The danger level for the second area A2 is computed using Equation 2:

Danger level=risk level×Min(30,speed difference with object O)/30 Equation 2

Note that the speed difference is measured in units of km/h.

According to Equation 2, this determination reflects the vehicle front-rear direction speed of the object O, and the danger level is a value corresponding to the risk level or lower.

The danger level for the third area A3 is computed using Equation 3:

Danger level=risk level+0.5×x Equation 3

Note that x=1 when an object O on a left side of the vehicle is moving toward the right or when an object O on a right side of the vehicle is moving toward the left.

x=0 in all other cases.

According to Equation 3, this determination reflects the left-right direction speed of the object O, and the danger level is a value corresponding to the risk level+0.5 in cases in which the object O is approaching the vehicle 12.

The output section 260 has a function of outputting caution information to the reporting device 25 in cases in which the determination section 250 has determined that danger is present. When the output section 260 outputs such caution information, the reporting device 25 displays an image on the monitor 26 to prompt the driver D to exercise caution, and outputs audio or an alarm from the speaker 28 to prompt the driver D to exercise caution.

Control Flow

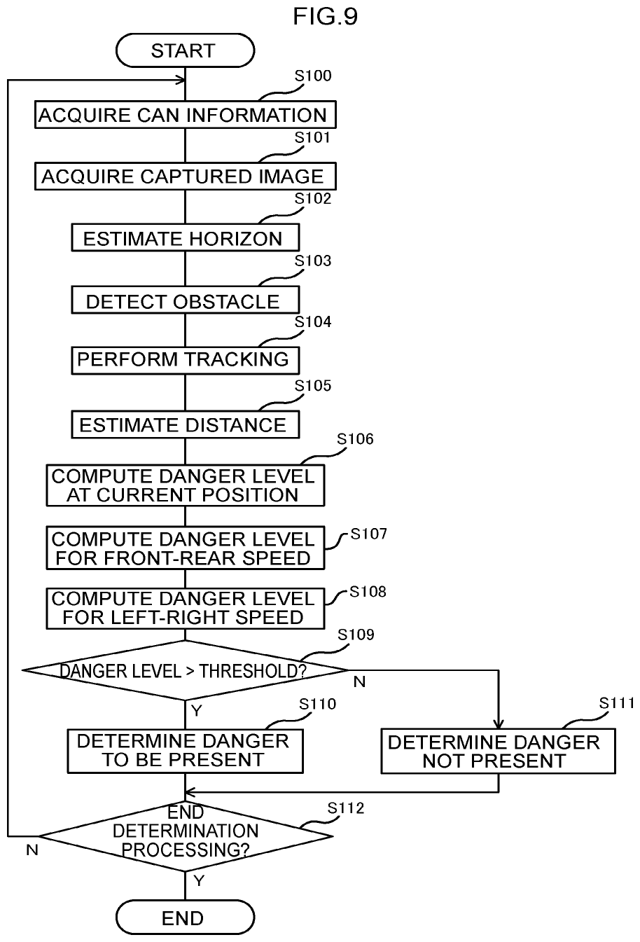

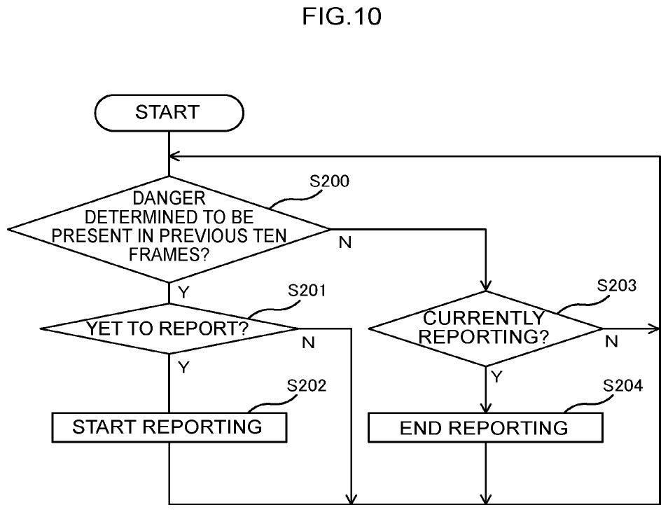

Explanation follows regarding a flow of the determination processing and the report processing executed by the controller 20 of the present exemplary embodiment, with reference to FIG. 9 and FIG. 10. The determination processing and the report processing is executed by the CPU 20A functioning as the setting section 200, the image acquisition section 210, the information acquisition section 220, the detection section 230, the generation section 240, the determination section 250, and the output section 260.

First, explanation follows regarding a flow of the determination processing, with reference to the flowchart of FIG. 9.

At step S100 in FIG. 9, the CPU 20A acquires the CAN information from the ECUs 22. For example, the CPU 20A acquires a steering angle sensor signal from the steering ECU 22A through the CAN information. As another example, the CPU 20A acquires an indicator light operation signal from the body ECU 22B through the CAN information.

At step S101, the CPU 20A acquires image information relating to a captured image captured by the camera 24.

At step S102, the CPU 20A estimates the horizon. The horizon is estimated using known technology. For example, the CPU 20A may detect straight line components of a road such as white lines on the road, and estimate horizon coordinates from an extracted point where all the straight lines intersect.

At step S103, the CPU 20A detects any objects O in the captured image. Specifically, the CPU 20A detects an object O such as a vehicle OV or a pedestrian OP using a known image recognition method or the like.

At step S104, the CPU 20A executes tracking. The object O detected at step S103 is thus tracked.

At step S105, the CPU 20A estimates a distance to the tracked object O. Specifically, a bounding box BB (see FIG. 6) is displayed around the object O in the captured image, and the CPU 20A computes the distance to the object O by inputting a Y coordinate of a base edge BL of the bounding box BB and a Y coordinate of the horizon in the captured image into a pre-prepared regression formula.

At step S106, the CPU 20A estimates the danger level at a current position. Specifically, in a case in which the object O is a vehicle OV, the CPU 20A defines a first area A1 as a determination area DA according to Table 1, and in cases in which the object O is a pedestrian OP, the CPU 20A defines a first area A1 as a determination area DA according to Table 2. The CPU 20A then substitutes a risk level applied according to the object O present in the first area A1 into Equation 1 to find the danger level. For example, in a case in which a pedestrian OP is present in the first area A1 as illustrated in FIG. 8, a risk level of 1.0 is applied, such that the danger level is 1.0 according to Equation 1.

At step S107, the CPU 20A estimates a danger level for front-rear speed. Specifically, in cases in which objects O are a vehicle OV and a pedestrian OP, the CPU 20A defines second areas A2 as determination areas DA according to Table 3. The CPU 20A then substitutes a risk level applied according to an object O present in the corresponding second area A2 into Equation 2 to find the danger level. For example, in a case in which the vehicle OV is present in the second area A2 set with a range spanning 12 m from the vehicle 12 and corresponding to the track width as illustrated in FIG. 7, a risk level of 0.9 is applied. According to Equation 2, this gives a danger level of 0.6 in a case in which the speed difference between the vehicle 12 and the vehicle OV is 20 km/h.

At step S108, the CPU 20A estimates the danger level for left-right speed. Specifically, in cases in which objects O are a vehicle OV and a pedestrian OP, the CPU 20A defines third areas A3 as determination areas DA according to Table 4. The CPU 20A then substitutes a risk level applied according to an object O present in the corresponding third area A3 in Equation 3 to find the danger level. For example, in a case in which a pedestrian OP is present in the third area A3 set with a range spanning 8 m from the vehicle 12 and corresponding to the track width as illustrated in FIG. 8, a risk level of 1.0 is applied. According to Equation 3, this gives a danger level of 1.5 in a case in which the pedestrian OP has entered the third area A3 by moving from the vehicle left toward the vehicle right of the vehicle 12.

At step S109, the CPU 20A determines whether or not any one of the danger levels computed for the respective determination areas DA exceeds the threshold. In the present exemplary embodiment, the threshold is set to 0.8. In cases in which the CPU 20A determines that any one of the danger levels exceeds the threshold, processing proceeds to step S110. On the other hand, in cases in which the CPU 20A determines that none of the danger levels exceeds the threshold, namely that all the danger levels are the threshold or lower, processing proceeds to step S111.

At step S110, the CPU 20A makes a determination of “danger”, indicating that there is a high probability that the vehicle 12 will contact the object O if the vehicle 12 continues on its present course.

At step S111, the CPU 20A makes a determination of “no danger”, indicating that there is a low probability that the vehicle 12 will contact the object O even if the vehicle 12 continues on its present course.

At step S112, the CPU 20A determines whether or not to end the determination processing. In cases in which the CPU 20A makes a determination to end the determination processing, the determination processing is ended. On the other hand, in cases in which the CPU 20A makes a determination not to end the determination processing, processing returns to step S100.

Next, explanation follows regarding a flow of the report processing, with reference to the flowchart of FIG. 10.

At step S200 in FIG. 10, the CPU 20A determines whether or not danger has been determined to be present in the captured image in any of the previous ten frames. In cases in which the CPU 20A determines that danger has been determined to be present in the captured image in any of the previous ten frames, processing proceeds to step S201. On the other hand, in cases in which the CPU 20A determines that danger has not been determined to be present in the captured image in any of the previous ten frames, processing proceeds to step S203.

At step S201, the CPU 20A determines whether or not the reporting device 25 has yet to report. In cases in which the CPU 20A determines that the reporting device 25 has yet to report, processing proceeds to step S202. On the other hand, in cases in which the CPU 20A determines that the reporting device 25 is not yet to report, namely that the reporting device 25 is currently reporting, processing returns to step S200.

At step S202, the CPU 20A starts reporting by outputting caution information to the reporting device 25. The reporting device 25 thus displays text such as “release accelerator” on the monitor 26, and outputs an alarm from the speaker 28.

At step S203, the CPU 20A determines whether or not the reporting device 25 is currently reporting. In cases in which the CPU 20A determines that the reporting device 25 is currently reporting, processing proceeds to step S204. On the other hand, in cases in which the CPU 20A determines that the reporting device 25 is not currently reporting, namely that the reporting device 25 is yet to report, processing returns to step S200.

At step S204, the CPU 20A stops output of the caution information to the reporting device 25 and ends the reporting. The display on the monitor 26 and the alarm from the speaker 28 of the reporting device 25 are thus ended.

### SUMMARY

The detection section 230 implemented by the controller 20 of the present exemplary embodiment detects an object O in a captured image captured by the camera 24 provided to the vehicle 12, and the generation section 240 generates determination areas DA according to the direction of movement of the vehicle 12. Three types of determination area DA, namely the first area A1 to the third area A3, are generated based on CAN information, as well as on the position and speed of the object O. Specifically, the first area A1 based solely on the position of the vehicle 12, the second area A2 reflecting the vehicle front-rear direction speed of the object O, and the third area A3 reflecting the left-right direction speed of the object O are respectively generated.

In cases in which the object O is present in any of the respective determination areas DA, the determination section 250 implemented by the controller 20 determines danger to be present according to the extent of its presence. In cases in which danger has been determined to be present, the controller 20 then reports the presence of danger to the driver D using the reporting device 25. The present exemplary embodiment thereby enables danger to be determined in consideration of information regarding the position, speed, and the like of the object O, as well as the CAN information of the vehicle 12. Since the generation section 240 generates the first area A1 to the third area A3, the present exemplary embodiment is moreover capable of taking plural conditions, such as the position and speed of the object O, into account during danger determination, thereby enabling danger determination to be performed according to the circumstances.

The determination section 250 implemented by the controller 20 of the present exemplary embodiment further quantifies the dangerousness of the object O present in a determination area DA as a danger level, and determines whether or not danger is present based on whether or not the danger level exceeds the threshold. The present exemplary embodiment thus enables danger to be determined according to the extent of a positional relationship between the vehicle 12 and the object O.

The determination section 250 of the present exemplary embodiment further performs the danger determination based on the captured image in ten frames. By maintaining danger determination over a prescribed duration, the present exemplary embodiment is thus capable of obtaining determination results that err on the safe side, even if determination results regarding a given object O vary between individual frames.

### REMARKS

Although the determination section 250 executes determination based on the first area A1, determination based on the second area A2, and determination based on the third area A3 in the present exemplary embodiment, the types of determination area DA are not limited to the first area A1 to the third area A3.

Although the determination section 250 computes danger levels and executes determination in sequence from the first area A1 through to the third area A3, the determination sequence is not limited thereto. The determination sequence may be modified according to the number of occupants in the vehicle 12, the content of the CAN information, weather conditions, or the like. In particular, for example, determination based on the third area A3 that relates to the left-right direction may be prioritized during rainy weather, in consideration of poor vehicle width direction visibility.

Although the threshold is set to a fixed value of 0.8 in the present exemplary embodiment, there is no limitation thereto, and the threshold may be modified according to the number of occupants in the vehicle 12, the content of the CAN information, weather conditions, or the like. For example, the threshold may be set so as to become lower as the steering angle of the steering wheel 14 acquired through the CAN information increases. Namely, the determination section 250 may perform determination by employing a threshold that is set lower as the steering angle of the steering wheel acquired through the CAN information configuring the travel information increases.

Although the steering angle information for the steering wheel 14 and the indicator light actuation information are acquired as the CAN information configuring the travel information of the vehicle 12, and these are employed in danger determination in the present exemplary embodiment, the CAN information employed in determination is not limited thereto. For example, brake actuation information, acceleration sensor information, millimeter-wave radar sensor information, or the like may be acquired through the CAN information and employed in danger determination.

Note that the various processing executed by the CPU 20A reading and executing software (programs) in the exemplary embodiment described above may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The processing described above may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Moreover, in the exemplary embodiment described above, explanation has been given regarding a configuration in which the respective programs are pre-stored (installed) on a computer-readable non-transitory storage medium. For example, the processing program 100 of the controller 20 is pre-stored in the ROM 20B. However there is no limitation thereto, and the respective programs may be provided in a format recorded on a non-transitory storage medium such as a compact disc read only memory (CD-ROM), digital versatile disc read only memory (DVD-ROM), or universal serial bus (USB) memory. Alternatively, the programs may be provided in a format downloadable from an external device over a network.

The processing of the exemplary embodiment described above is not limited to being executed by a single processor, and may be executed by plural processors working in coordination. The processing flows described in the above exemplary embodiment are merely examples, and unnecessary steps may be omitted, new steps may be added, and the processing sequence may be changed within a range not departing from the spirit thereof.

What is claimed is:

1. A determination device, comprising a processor, the processor being configured to:
detect an object in an image captured by an image capture section provided at a vehicle;
generate a determination area in accordance with a direction of movement of the vehicle based on travel information of the vehicle and based on a position and a speed of the object; and
determine danger to be present in a case in which the object is present in the determination area.

2. The determination device of claim 1, wherein the processor is further configured to:
compute a danger level with respect to the object present in the determination area; and
determine danger to be present in a case in which the computed danger level exceeds a threshold.

3. The determination device of claim 2, wherein the processor is further configured to perform determination employing the threshold, and the threshold is lowered in conjunction with an increase in a steering angle of a steering wheel acquired from the travel information.

4. The determination device of claim 2, wherein:
the processor is further configured to generate a plurality of determination areas based on the travel information and based on the position and the speed of the object; and
the processor is further configured to compute the danger level for each of the determination areas and to determine danger to be present in a case in which the danger level exceeds a threshold in any one of the determination areas.

5. The determination device of claim 4, wherein the determination areas include:
a first area for which the processor performs determination without considering the speed of the object;
a second area for which the processor performs determination in consideration of a vehicle front-rear direction speed of the object; and
a third area for which the processor performs determination in consideration of a vehicle left-right direction speed of the object.

6. The determination device of claim 1, wherein, in a case in which the processor detects a pedestrian instead of another vehicle, the processor increases a width of the determination area in comparison to a case in which the processor detects another vehicle.

7. The determination device of claim 1, wherein, in a case in which actuation information for an indicator light of the vehicle has been acquired, the processor increases a width of the determination area in comparison to a case in which the indicator light actuation information has not been acquired.

8. The determination device of claim 1, wherein the processor is further configured to maintain a determination that danger is present at a current timing in a case in which danger has been determined to be present based on the captured image in a prescribed number of preceding frames.

9. A determination method in which a computer executes processing, the processing comprising:
detection processing to detect an object in an image captured by an image capture section provided at a vehicle;
generation processing to generate a determination area in accordance with a direction of movement of the vehicle based on travel information of the vehicle and based on a position and a speed of the object; and
determination processing to determine danger to be present in a case in which the object is present in the determination area.

10. A non-transitory storage medium storing a program executable by a computer to perform processing, the processing comprising:
detection processing to detect an object in an image captured by an image capture section provided at a vehicle;
generation processing to generate a determination area in accordance with a direction of movement of the vehicle based on travel information of the vehicle and based on a position and a speed of the object; and
determination processing to determine danger to be present in a case in which the object is present in the determination area.
